(19) United States
(12) Patent Application Publication
(10) Pub. No.: US 2018/0298635 A1
(43) Pub. Date: Oct. 18, 2018

(54) REBOUND APPARATUS FOR A LOCK ASSEMBLY

(71) Applicant: TAIWAN FU HSING INDUSTRIAL CO., LTD., Kaohsiung City (TW)

(72) Inventor: Fu-Chih Huang, Kaohsiung City (TW)

(21) Appl. No.: 15/623,482

(22) Filed: Jun. 15, 2017

(30) Foreign Application Priority Data
Apr. 18, 2017 (TW) 106205366

(51) Int. Cl. E05B 3/06; E05B 63/00

(52) U.S. Cl. CPC E05B 3/065; E05B 63/006

(57) ABSTRACT

A rebound apparatus for a lock assembly includes a rotation axle, a driving plate and a torsion spring. One end of the rotation axle is passed through a through hole of a tube to connect with a body of the lock assembly, and the other end of the rotation axle protrudes from the tube. The driving plate is disposed in the through hole and is connected with the rotation axle for simultaneous rotation. The driving plate includes a first notch and a second notch which respectively coincide with a first blocking notch and a second blocking notch of the tube. The torsion spring includes a first pushing portion extending to the first notch and the first blocking notch, and a second pushing portion extending to the second notch and the second blocking notch.

### FIELD OF THE INVENTION

This invention relates to a lock assembly, and more particularly relates to a rebound apparatus for a lock assembly.

### BACKGROUND OF THE INVENTION

For opening or closing a door, the user generally rotates the handle to rotate the rotation axle of the conventional lock assembly, and then allows the rotation axle to drive the retractor and the latch bolt in operation. The rotation axle also twists the torsion spring mounted in the escutcheon to generate and store the torsional force during rotation, and the torsion spring can release the stored energy to return the rotation axle, the handle and the latch bolt to their original positions when the user releases the handle. However, the torsion spring of the conventional lock assembly is disposed in an accommodation space of the escutcheon, and the entire volume of the conventional lock assembly is unable to be reduced because of the thicker escutcheon.

### SUMMARY

The primary object of the present invention is to allow a torsion spring disposed in a tube to generate and store the torsional energy during rotating a rotation axle, and to release the stored energy for returning the rotation axle to its original position when the external force is removed, wherein one end of the torsion spring contacts against a driving plate which is coupled with the rotation axle, and the other end of the torsion spring is fixed in the tube.

The rebound apparatus for a lock assembly including a body and a tube connecting to the body comprises a rotation axle, a driving plate and a torsion spring. One end of the rotation axle is passed through a through hole of the tube to connect with the body, and the other end of the rotation axle protrudes from the tube. The driving plate is disposed in the through hole of the tube, and is connected to the rotation axle for simultaneous rotation with the rotation axle. The driving plate includes a first notch and a second notch, and the tube includes a first blocking notch and a second blocking notch. The first notch coincides with the first blocking notch, and the second notch coincides with the second blocking notch. The torsion spring includes a first pushing portion and a second pushing portion. The first pushing portion extends to the first notch and the first blocking notch, and the second pushing portion extends to the second notch and the second blocking notch.

In the present invention, one end of the torsion spring is twisted by the first or second notch of the driving plate, and the other end of the torsion spring is positioned in the first or second blocking notch of the tube. For this reason, the torsion spring can store the torsional energy while the driving plate is rotated to twist the torsion spring, and can release the stored energy to return the driving plate to its original position when the external force is removed. Furthermore, reducing the escutcheon thickness and the entire volume of the lock assembly are available because the rebound apparatus is mounted in the tube.

### DESCRIPTION OF THE DRAWINGS

FIG. 1 is a perspective assembly diagram illustrating a lock assembly mounted on a door in accordance with one embodiment of the present invention.

FIG. 2 is a perspective exploded diagram illustrating the lock assembly in accordance with the embodiment of the present invention.

FIG. 3 is a perspective exploded diagram illustrating the lock assembly in accordance with the embodiment of the present invention.

FIG. 4 is a perspective assembly diagram illustrating a driving plate in accordance with the embodiment of the present invention.

FIG. 5 is a lateral view diagram illustrating the driving plate in accordance with the embodiment of the present invention.

FIG. 6 is a perspective exploded diagram illustrating the driving plate, a tube and a torsion spring in accordance with the embodiment of the present invention.

FIG. 7 is a perspective assembly diagram illustrating the driving plate, the tube and the torsion spring in accordance with the embodiment of the present invention.

FIG. 8 is a perspective cross-section view diagram illustrating a housing, the driving plate, the tube and the torsion spring in accordance with the embodiment of the present invention.

FIG. 9 is cross-section view diagram illustrating the driving plate, the tube and the torsion spring in accordance with the embodiment of the present invention.

FIG. 10 is a cross-section view diagram illustrating the driving plate, the tube and the torsion spring in accordance with the embodiment of the present invention.

FIG. 11 is a perspective exploded diagram illustrating the lock assembly in accordance with the embodiment of the present invention.

FIG. 12 is a lateral view diagram illustrating the lock assembly in accordance with the embodiment of the present invention.

FIG. 13 is a perspective exploded diagram illustrating the lock assembly in accordance with the embodiment of the present invention.

### DETAILED DESCRIPTION OF THE INVENTION

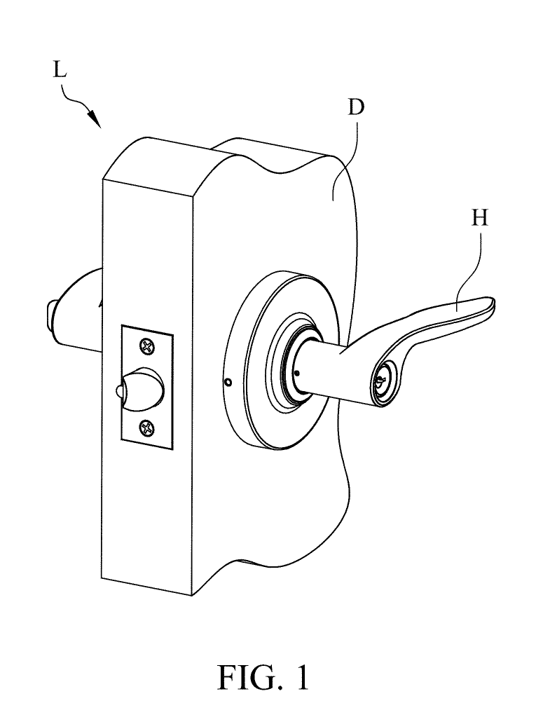

With reference to FIGS. 1, 2 and 3, a lock assembly L in accordance with one embodiment of the present invention is mounted on a door D, and includes a body 100, a tube 200 and a rebound apparatus 300. The body 100 is mounted in a mounting hole DI of the door D and includes a retractor (not shown), a latch bolt 110 and a housing 120, wherein the retractor is located in the housing 120 and is adapted to retract or extend the latch bolt 110. The tube 200 is connected to the housing 120 of the body 100 and includes a through hole 210, and the tube 200 has threads on its external surface in this embodiment.

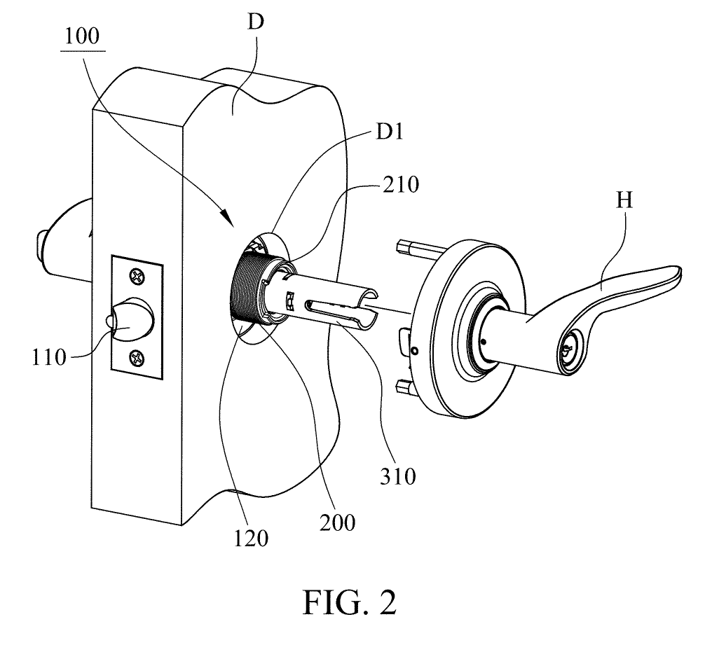

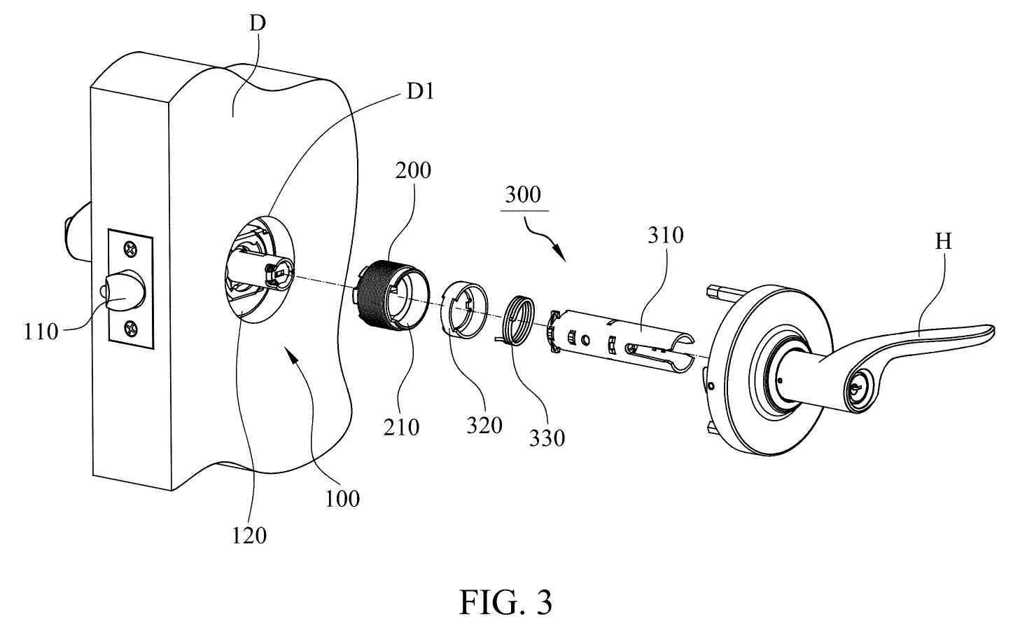

With reference to FIGS. 2 and 3, the rebound apparatus 300 includes a rotation axle 310, a driving plate 320 and a torsion spring 330. One end of the rotation axle 310 is passed through the through hole 210 of the tube 200 to connect with the retractor of the body 100, and the other end of the rotation axle 310 protrudes from the tube 200 to connect with a handle H for simultaneous rotation. Hence, the rotation axle 310 can allow the retractor to operate for opening or closing the door D when the user rotates the handle H. The driving plate 320 is disposed in the through hole 210 of the tube 200, and is connected to the rotation axle 310 for simultaneous rotation with the rotation axle 310. As a result, the driving plate 320 is capable of rotating with the rotation axle 310 when the handle H rotates the rotation axle 310.

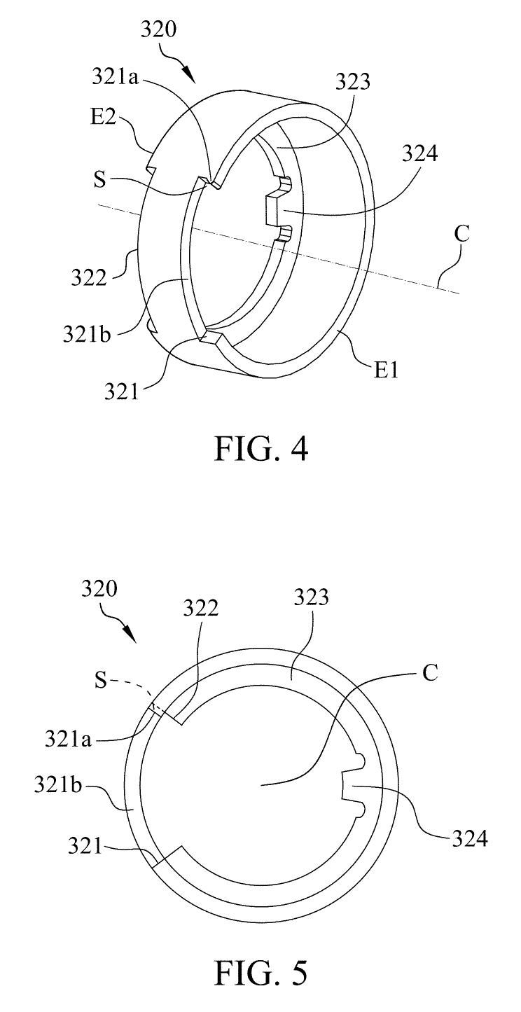

With reference to FIGS. 4 and 5, the driving plate 320 includes a first end E1, a second end E2, a first notch 321, a second notch 322, a flange 323 and a protrusion 324, wherein the first notch 321 is located on the first end E1, and the second notch 322, the flange 323 and the protrusion 324 are located on the second end E2. The second notch 322 is recessed into the flange 323. The flange 323 and the protrusion 324 extend toward a central axis C of the driving plate 320, and the protrusion 324 protrudes from the flange 323.

With reference to FIGS. 4, 5 and 6, the first notch 321 of the driving plate 320 preferably includes a restriction protrusion 321a, and a restriction space S is formed between the restriction protrusion 321a and a notch bottom surface 321b of the first notch 321, wherein the restriction space S is provided for disposing one end of the torsion spring 330. In this embodiment, the torsion spring 330 includes a first pushing portion 331 and a second pushing portion 332, and the first pushing portion 331 is restricted in the restriction space S to prevent the torsion spring 330 from separating from the driving plate 320 during compressing.

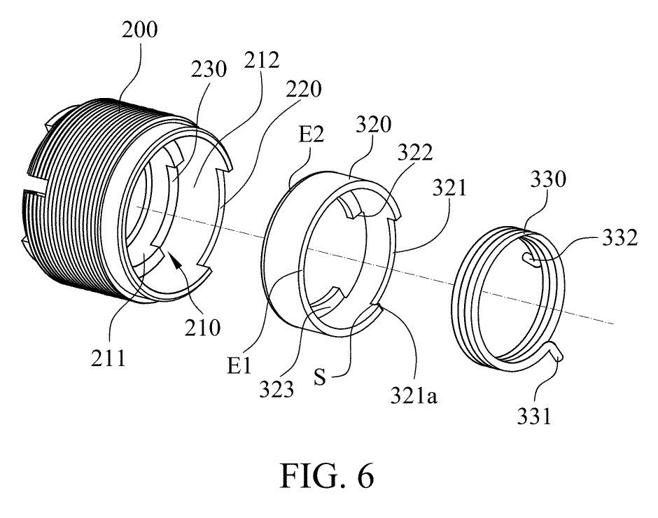

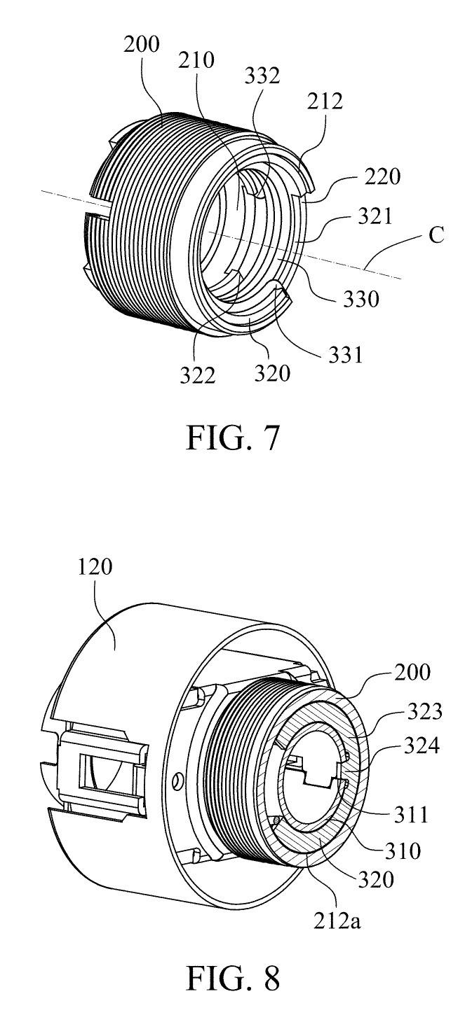

With reference to FIGS. 6 and 7, the through hole 210 of the tube 200 includes a hole wall 211, and an accommodation groove 212 is recessed into the hole wall 211. The driving plate 320 is disposed in the accommodation groove 212, and the torsion spring 330 is assembled on the driving plate 320. The tube 200 includes a first blocking notch 220 and a second blocking notch 230, wherein the first blocking notch 220 coincides with the first notch 321, and the second blocking notch 230 coincides with the second notch 322. The first pushing portion 331 of the torsion spring 330 extends to the first notch 321 and the first blocking notch 220 along a radial direction with respect to the central axis C, and the second pushing portion 332 of the torsion spring 330 extends to the second notch 322 and the second blocking notch 230 along an axial direction with respect to the central axis C.

With reference to FIG. 8, it is a perspective cross-section view diagram of the rebound apparatus 300 and the body 100. The rotation axle 310 penetrates through the tube 200 and the driving plate 320, and the driving plate 320 is located between the tube 200 and the rotation axle 310. In this embodiment, the flange 323 of the driving plate 320 is restricted between a groove wall 212a of the accommodation groove 212 and the rotation axle 310 for maintaining the position of the driving plate 320 in the tube 200. Furthermore, the rotation axle 310 includes an actuating groove 311, and the protrusion 324 of the driving plate 320 is capable of inserting into the actuating groove 311 of the rotation axle 310 to allow the driving plate 320 to simultaneously rotate with the rotation axle 310.

With reference to FIGS. 7, 8, 9 and 10, the tube 200 is positioned on the body 100, and the driving plate 320 is capable of rotating with the rotation axle 310 simultaneously, hence the lateral wall of the first notch 321 of the driving plate 320 enables to push the first pushing portion 331 of the torsion spring 330 when the rotation axle 310 drives the driving plate 320 to rotate in counterclockwise direction, and the second pushing portion 332 of the torsion spring 330 is positioned on the lateral wall of the second blocking notch 230 of the tube 200 to allow the torsion spring 330 to be twisted and store the torsional energy. And while the external force is removed, the first pushing portion 331 of the torsion spring 330 is capable of rebounding to return the driving plate 320 and the rotation axle 310 to their original positions. On the contrary, the lateral wall of the second notch 322 of the driving plate 320 enables to push the second pushing portion 332 of the torsion spring 330 when the rotation axle 310 drives the driving plate 320 to rotate in clockwise direction, and the first pushing portion 331 of the torsion spring 330 is positioned on the lateral wall of the first blocking notch 220 of the tube 200 to allow the torsion spring to be twisted and store the torsional energy. And while the external force is removed, the second pushing portion 332 of the torsion spring 330 is capable of rebounding to return the driving plate 320 and the rotation axle 310 to their original positions.

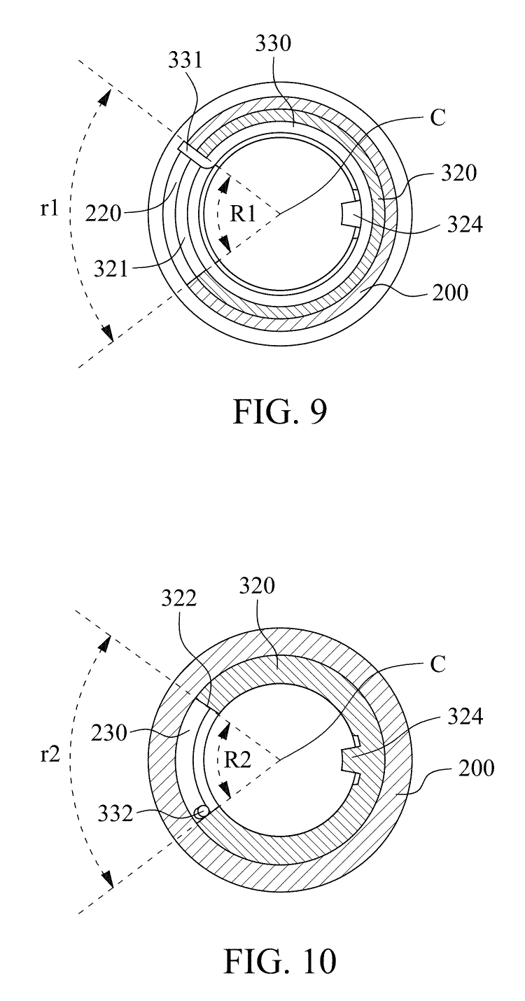

With reference to FIG. 9, preferably, the first notch 321 of the driving plate 320 is a curved notch with a radian R1 around the central axis C of the driving plate 320, and the first blocking notch 220 of the tube 200 is also a curved notch with a radian r1 around the central axis C of the driving plate 320, wherein the radian R1 of the first notch 321 is substantially equal to the radian r1 of the first blocking notch 220. With reference to FIG. 10, the second notch 322 of the driving plate 320 is a curved notch with a radian R2 around the central axis C of the driving plate 320, and the second blocking notch 230 of the tube 200 is also a curved notch with a radian r2 around the central axis C of the driving plate 320, wherein the radian R2 of the second notch 322 is substantially equal to the radian r2 of the second blocking notch 230. For this reason, the maximum rotation angles of the driving plate 320 in clockwise and counterclockwise directions are identical.

The driving plate 320 and the torsion spring 330 are disposed in the tube 200, and the driving plate 320 and the rotation axle 310 are allowed to rotated simultaneously, so the torsion spring 330 is capable of being twisted through the rotation axle 310 and the driving plate 320 during rotating the handle H, and the stored energy from the torsion spring 330 is capable of allowing the driving plate 320, the rotation axle 310 and the handle H to return to their original positions while the external force is removed.

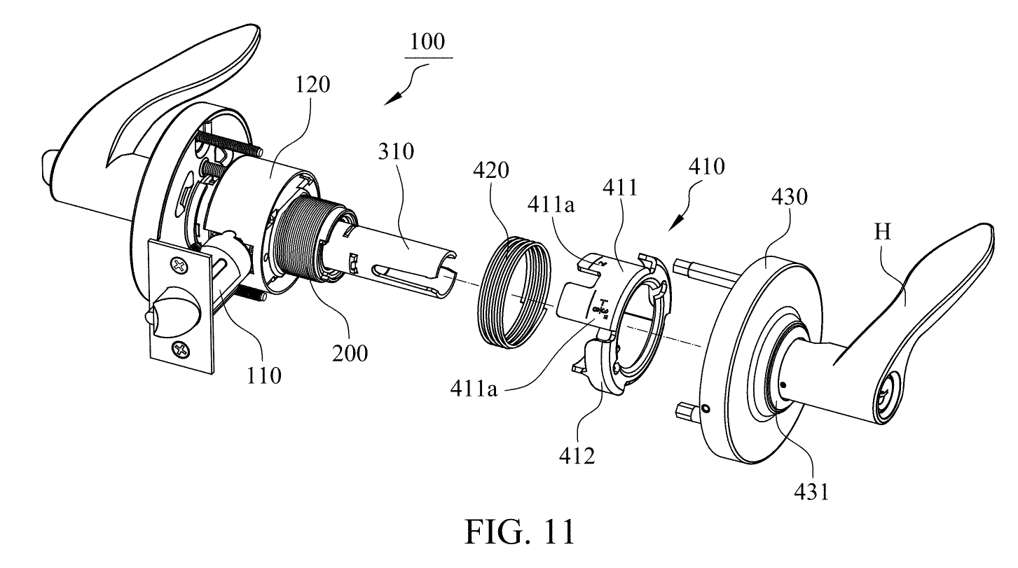

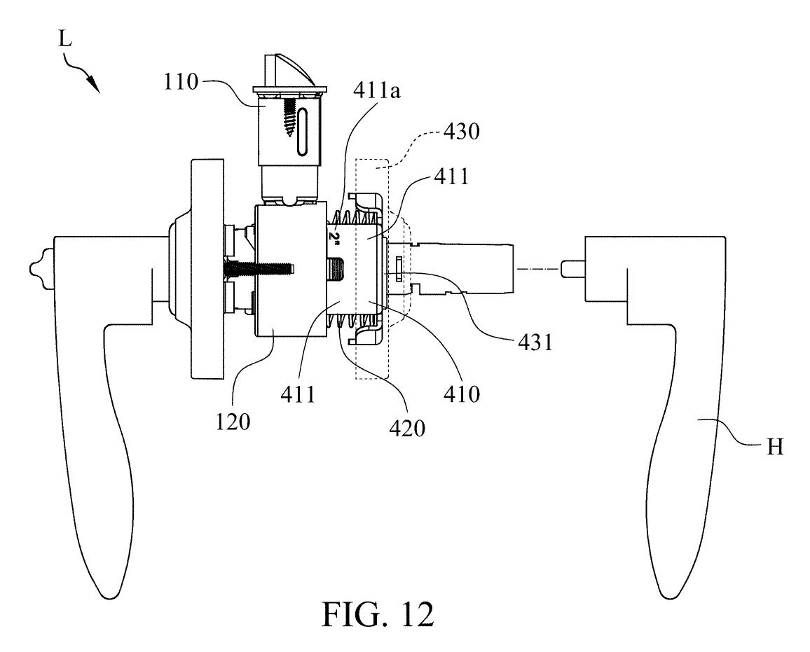

With reference to FIGS. 11 and 12, the lock assembly L includes an adjusting plate 410, a compression spring 420 and an escutcheon 430 in this embodiment, wherein the escutcheon 430 is coupled with the tube 200, the adjusting plate 410 is located between the body 100 and the escutcheon 430, and two ends of the compression spring 420 respectively contact against the body 100 and the adjusting plate 410 to allow the adjusting plate 410 to press on the escutcheon 430. In this embodiment, the escutcheon 430 includes a coupling portion 431 having threads, wherein the coupling portion 431 is utilized to screw the escutcheon 430 into the tube 200. Consequently, the lock assembly L is able to be mounted on the door D having different thickness because the distance between the escutcheon 430 and another escutcheon is adjustable by rotating the escutcheon 430.

With reference to FIG. 12, owing to the pressing force of the compression spring 420, the adjusting plate 410 is able to continuously contact against the escutcheon 430 and move with the escutcheon 430 when the escutcheon 430 is rotated to adjust the distance relative to another one. Preferably, the adjusting plate 410 includes an identification portion 411, wherein a part of the identification portion 411 is located in the body 100, and other part of the identification portion 411 is located outside the body 100. A plurality of size marks 411a are marked on the identification portion 411, and one of the size marks 411a is revealed on the edge of the body 100. The size mark revealed on the edge of the body 100 is used for identifying whether the position of the escutcheon 430 matches the thickness of the door D during the installer of the lock assembly L rotates the escutcheon 430.

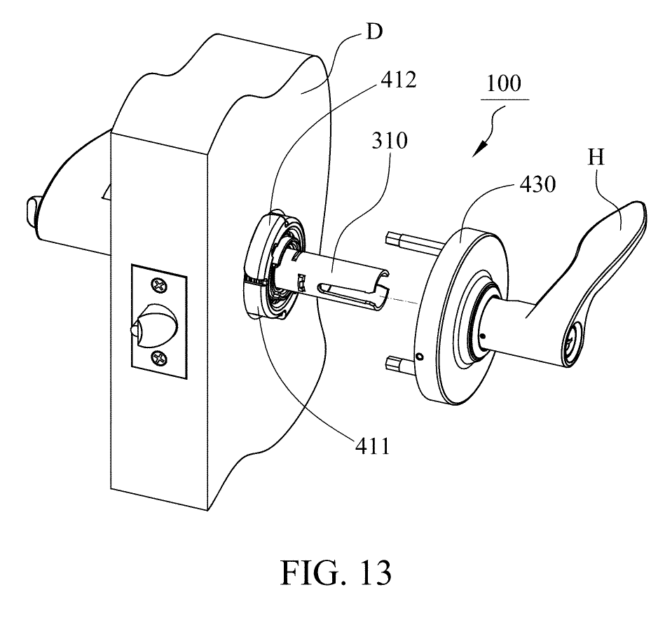

With reference to FIGS. 11 and 13, the adjusting plate 410 includes an embedding portion 412, which is located outside the body 100. When the escutcheon 430 is coupled to the tube 200 and covered the door D, the escutcheon 430 is capable of pushing the adjusting plate 410 to allow the embedding portion 412 to embed into the door D steadily. The embedding portion 412 is utilized to prevent the adjusting plate 410 from separating from the lock assembly L with the escutcheon 430 when the installer disassembles the escutcheon 430.

In the present invention, one end of the torsion spring 330 is twisted by the first notch 321 or the second notch 322 of the driving plate 320, and the other end of the torsion spring 330 is positioned in the first blocking notch 220 or the second blocking notch 230 of the tube 200. Hence, the torsion spring 330 is capable of storing the torsional energy during rotating the driving plate 320, and is capable of using the stored energy to return the driving plate 320 to its original position while the external force is removed. In addition, the thickness of the escutcheon 430 and the entire volume of the lock assembly L can be reduced owing to the rebound apparatus 300 is disposed in the tube 200.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. A rebound apparatus for a lock assembly, the lock assembly comprising a body and a tube connecting to the body, the rebound apparatus comprising:
a rotation axle, wherein one end of the rotation axle is passed through a through hole of the tube to connect with the body, and the other end of the rotation axle protrudes from the tube;
a driving plate disposed in the through hole of the tube, the driving plate is connected to the rotation axle for simultaneous rotation with the rotation axle, wherein the driving plate includes a first notch and a second notch, and the tube includes a first blocking notch and a second blocking notch, and wherein the first notch coincides with the first blocking notch, and the second notch coincides with the second blocking notch; and
a torsion spring including a first pushing portion and a second pushing portion, wherein the first pushing portion extends to the first notch and the first blocking notch, and the second pushing portion extends to the second notch and the second blocking notch.

2. The rebound apparatus for a lock assembly in accordance with claim 1, wherein the first notch of the driving plate includes a restriction protrusion, and a restriction space is formed between the restriction protrusion and a notch bottom surface of the first notch, and wherein the first pushing portion of the torsion spring is restricted in the restriction space.

3. The rebound apparatus for a lock assembly in accordance with claim 1, wherein a radian of the first notch is substantially equal to that of the first blocking notch, and a radian of the second notch is substantially equal to that of the second blocking notch.

4. The rebound apparatus for a lock assembly in accordance with claim 2, wherein a radian of the first notch is substantially equal to that of the first blocking notch, and a radian of the second notch is substantially equal to that of the second blocking notch.

5. The rebound apparatus for a lock assembly in accordance with claim 1, wherein the driving plate includes a first end and a second end, and the first notch is located on the first end, and wherein the second end includes a flange extending toward a central axis of the driving plate, and the second notch is recessed into the flange.

6. The rebound apparatus for a lock assembly in accordance with claim 5, wherein the through hole of the tube includes a hole wall, an accommodation groove is recessed into the hole wall, and the driving plate is disposed in the accommodation groove, and wherein the flange of the driving plate is restricted between a groove wall of the accommodation groove and the rotation axle.

7. The rebound apparatus for a lock assembly in accordance with claim 5, wherein the driving plate includes a protrusion which is located on the second end and extends toward the central axis of the driving plate, and wherein the rotation axle includes an actuating groove, and the protrusion protrudes from the flange and is inserted into the actuating groove of the rotation axle.

8. The rebound apparatus for a lock assembly in accordance with claim 1, wherein the first pushing portion of the torsion spring extends along a radial direction with respect to a central axis of the driving plate, and the second pushing portion of the torsion spring extends along an axial direction with respect to the central axis of the driving plate.

9. The rebound apparatus for a lock assembly in accordance with claim 1, wherein the lock assembly includes an adjusting plate, a compression spring and an escutcheon, wherein the escutcheon is coupled with the tube, the adjusting plate is located between the body and the escutcheon, and two ends of the compression spring respectively contact against the body and the adjusting plate to allow the adjusting plate to press on the escutcheon.

10. The rebound apparatus for a lock assembly in accordance with claim 9, wherein the adjusting plate include an identification portion, a part of the identification portion is located in the body, and other part of the identification portion is located outside the body, wherein a plurality of size marks are marked on the identification portion, and one of the size marks is revealed on an edge of the body.

11. The rebound apparatus for a lock assembly in accordance with claim 9, wherein the adjusting plate includes an embedding portion located outside the body, and the escutcheon is capable of pushing the adjusting plate to allow the embedding portion to embed into a door when the escutcheon is coupled with the tube and covered the door.

12. The rebound apparatus for a lock assembly in accordance with claim 10, wherein the adjusting plate includes an embedding portion located outside the body, and the escutcheon is capable of pushing the adjusting plate to allow the embedding portion to embed into a door when the escutcheon is coupled with the tube and covered the door.
